(19) United States
(12) Patent Application Publication
(10) Pub. No.: US 2013/0179353 A1
(43) Pub. Date: Jul. 11, 2013

(54) SECURE FINANCIAL TRANSACTIONS USING MULTIPLE COMMUNICATION TECHNOLOGIES

(71) Applicants: Alexander S. Ran, Palo Alto, CA (US); Ajay Tripathi, San Ramon, CA (US); Eugene Krivopaltsev, San Jose, CA (US)

(72) Inventors: Alexander S. Ran, Palo Alto, CA (US); Ajay Tripathi, San Ramon, CA (US); Eugene Krivopaltsev, San Jose, CA (US)

(73) Assignee: INTUIT INC., Mountain View, CA (US)

(21) Appl. No.: 13/347,599

(22) Filed: Jan. 10, 2012

(51) Int. Cl. G06Q 30/06; H04L 9/28

(52) U.S. Cl. 705/77; 705/26.1; 705/26.41

(57) ABSTRACT

During a financial technique, electronic devices may exchange, using a first communication technique, information with each other to establish a secure connection between the electronic devices when they are proximate to each other. After the secure connection is established, the electronic devices may hand off communication with each other from the first communication technique to a second communication technique that supports communication at a higher data rate and over longer distances than the first communication technique. Moreover, the electronic devices may communicate, using the second communication technique and the secure connection, additional information associated with the financial transaction with each other to facilitate completion of the financial transaction.

### BACKGROUND

The present disclosure relates to techniques for conducting financial transactions. More specifically, the present disclosure relates to a technique for establishing a secure connection between electronic devices using a first communication technique, and then completing the financial transactions by communicating information between the electronic devices using a second communication technique.

Portable electronic devices, such as cellular telephones, are increasingly being used to conduct financial transactions. For example, using near-field communication (NFC), financial information associated with a financial instrument (such as a credit or debit card), which is stored on a secure element of a cellular telephone, can be communicated in a secure manner when the cellular telephone and a point-of-sale terminal are in immediate proximity or are touching.

However, because of security and fraud concerns, financial transactions are becoming increasingly complicated. In particular, in order to complete payment for a product or a service, a customer now often needs to do more than merely authorize the transfer of funds. For example, the customer may need to provide: a personal identification number (PIN), details of the financial transaction, their signature, etc. In addition, the customer often needs to perform additional operations to exchange information associated with: coupons, loyalty programs, future promotional offers, store-account information, etc.

It can be difficult to perform these additional operations using NFC because NFC has a low data rate and typically cannot quickly communicate large amounts of information. Therefore, in order to convey all the required information needed to complete a financial transaction, a customer may need to ‘touch’ or bring their cellular telephone in close proximity to a point-of-sale terminal multiple times. Alternatively, the customer may need to interact with a separate payment terminal. In addition, some operations in the payment process (such as authorization by the issuer of a credit card or a debit card) may take a long time (for example, 10-20 seconds). These constraints can be awkward and annoying for the customer, which may reduce their willingness to conduct such financial transactions and, therefore, may reduce commercial activity.

### SUMMARY

The disclosed embodiments relate to an electronic device that completes a financial transaction. During operation, the electronic device exchanges, using a first communication technique, information with a second electronic device to establish a secure connection between the electronic device and the second electronic device when the electronic device and the second electronic device are proximate to each other. After the secure connection is established, the electronic device hands off communication with the second electronic device from the first communication technique to a second communication technique, where the second communication technique supports communication at a higher data rate and over longer distances than the first communication technique. Moreover, the electronic device communicates, using the second communication technique and the secure connection, additional information associated with the financial transaction with the second electronic device, where the additional information facilitates completion of the financial transaction.

Note that the electronic device may establish the secure connection when a user of one of the electronic device and the second electronic device positions the electronic device and the second electronic device proximate to each other. For example, proximate may include physical contact between the electronic device and the second electronic device. Furthermore, after the electronic device and the second electronic device are positioned proximate to each other, the remaining operations may be performed without further action by users of the electronic device and the second electronic device and/or without the electronic device and the second electronic device remaining proximate to each other.

Additionally, the first communication technique may include near-field communication and/or the second communication technique may include: Bluetooth™ (from the Bluetooth Special Interest Group of Kirkland, Wash.), wireless communication and/or the Internet.

In some embodiments, the information includes a cryptographic key. For example, the cryptographic key may be locally generated in one of the electronic device and the second electronic device. Alternatively or additionally, the information may include an identity attribute.

Note that the secure connection may include a pairwise connection between the electronic device and the second electronic device.

In some embodiments, after exchanging the information, the electronic device: provides the information to a service provider at a remote location from the electronic device and the second electronic device; and receives connection information from the service provider which establishes the secure connection between the electronic device and the second electronic device. Alternatively or additionally, after exchanging the information, the electronic device and/or the second electronic device may establish the secure connection between the electronic device and the second electronic device based on the information.

Moreover, the additional information may correspond to a multiple-stage financial transaction, where a given stage involves communication of at least some of the additional information between the electronic device and the second electronic device. For example, the additional information may include information associated with: an item to be purchased, a financial instrument used to pay for the item, a discount offer for the financial transaction, a discount offer for a second financial transaction after the financial transaction, a customer loyalty program, and/or a receipt for the financial transaction.

Another embodiment provides a method that includes at least some of the operations performed by the electronic device.

Another embodiment provides a computer-program product for use with the electronic device. This computer-program product includes instructions for at least some of the operations performed by the electronic device.

### BRIEF DESCRIPTION OF THE FIGURES

FIG. 1 is a flow chart illustrating a method for completing a financial transaction in accordance with an embodiment of the present disclosure.

FIG. 2 is a flow chart illustrating the method of FIG. 1 in accordance with an embodiment of the present disclosure.

FIG. 3 is a block diagram illustrating a system that performs the method of FIGS. 1 and 2 in accordance with an embodiment of the present disclosure.

FIG. 4 is a block diagram illustrating an electronic device that performs the method of FIGS. 1 and 2 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an electronic device, a technique for completing a financial transaction, and a computer-program product (e.g., software) for use with the electronic device are described. During this financial technique, electronic devices may exchange, using a first communication technique, information with each other to establish a secure connection between the electronic devices when they are proximate to each other. After the secure connection is established, the electronic devices may hand off communication with each other from the first communication technique to a second communication technique that supports communication at a higher data rate and over longer distances than the first communication technique. Moreover, the electronic devices may communicate, using the second communication technique and the secure connection, additional information associated with the financial transaction with each other to facilitate completion of the financial transaction.

This financial technique may allow users of the electronic devices to reduce the effort and the inconvenience associated with completion of the financial transaction. For example, after the secure connection is established, the users may not need to keep the electronic devices proximate to each other. Thus, communication between the electronic devices via the secure connection may occur over longer distances. This may eliminate the need for the users to ‘touch’ or bring the electronic devices in close proximity multiple times during the financial transaction as the additional information is exchanged. Furthermore, after the secure connection is established, the users may not need to explicitly perform any additional actions. By simplifying the process of completing the financial transaction and making it more convenient for the users, the financial technique may improve the buying and payment experience and, thus, may increase commercial activity.

In the discussion that follows, a recipient, an entity, or a user may include: an individual (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

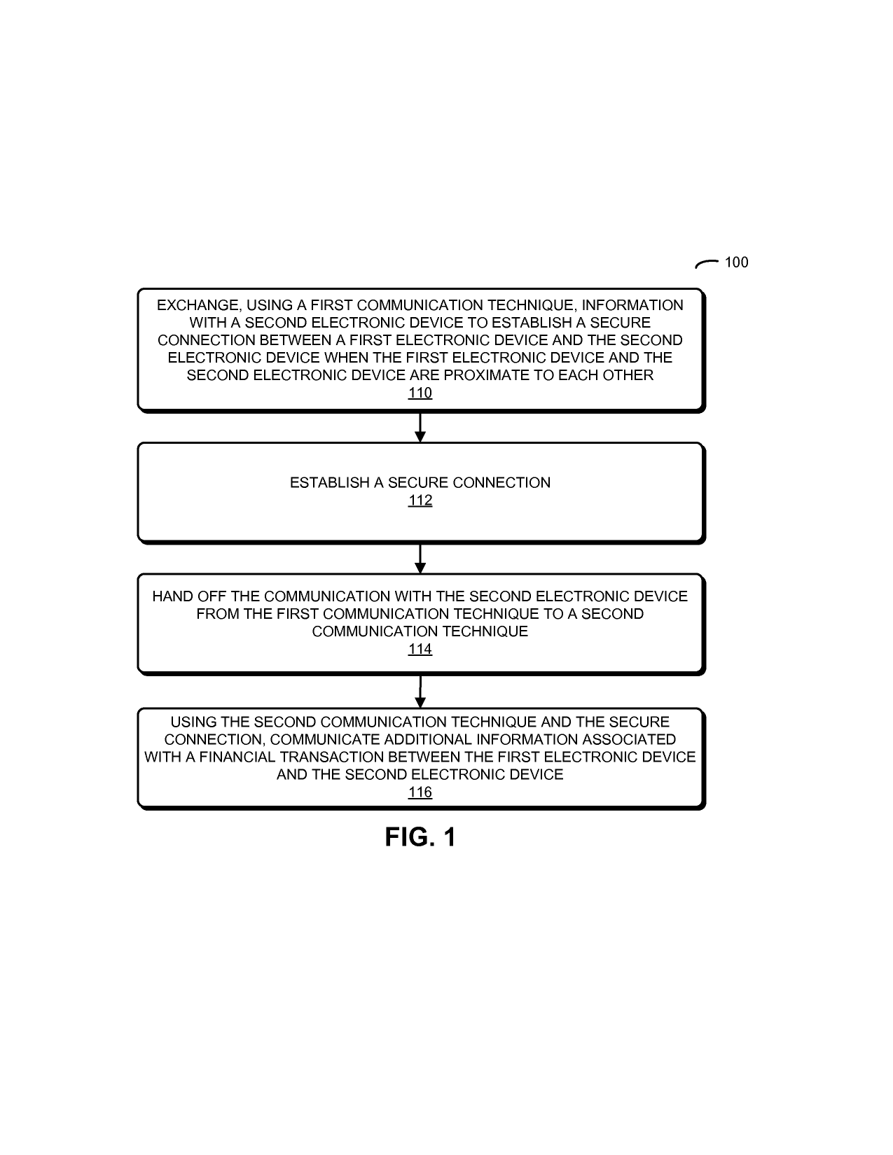

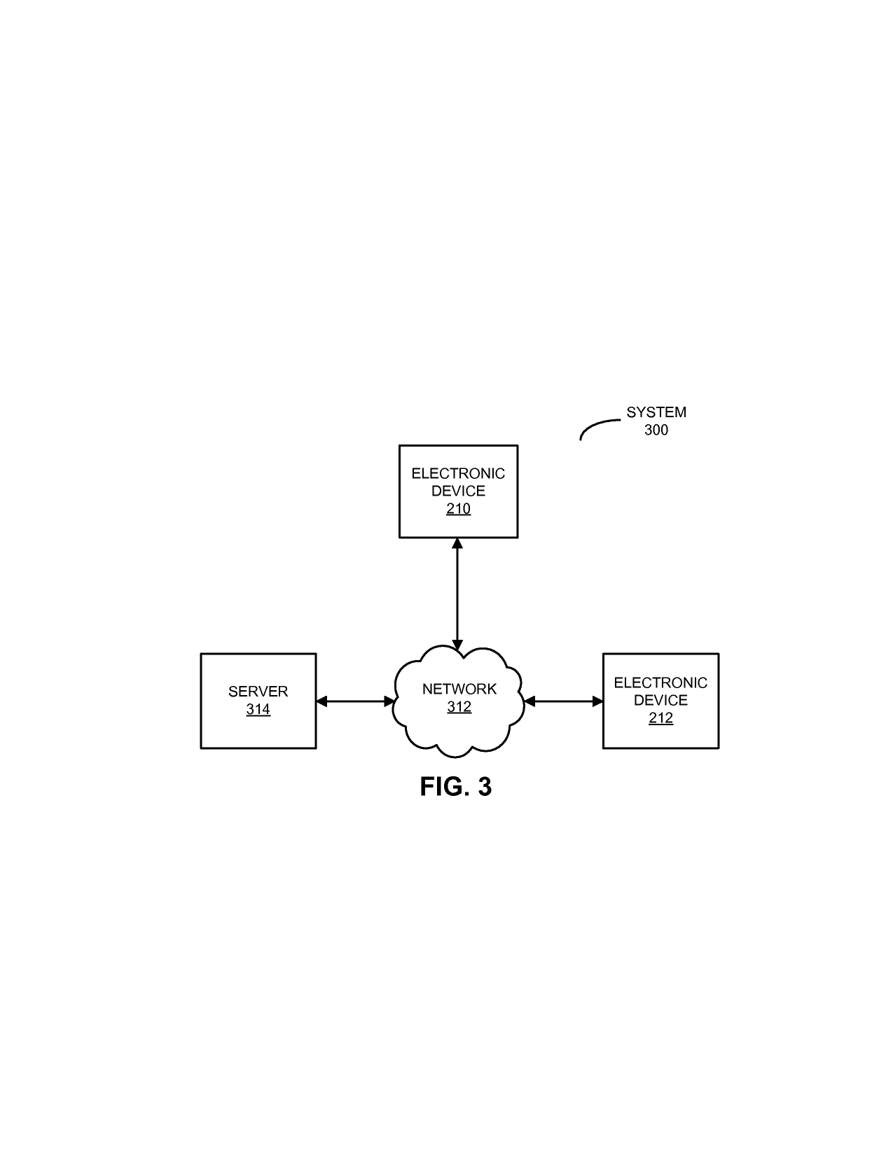

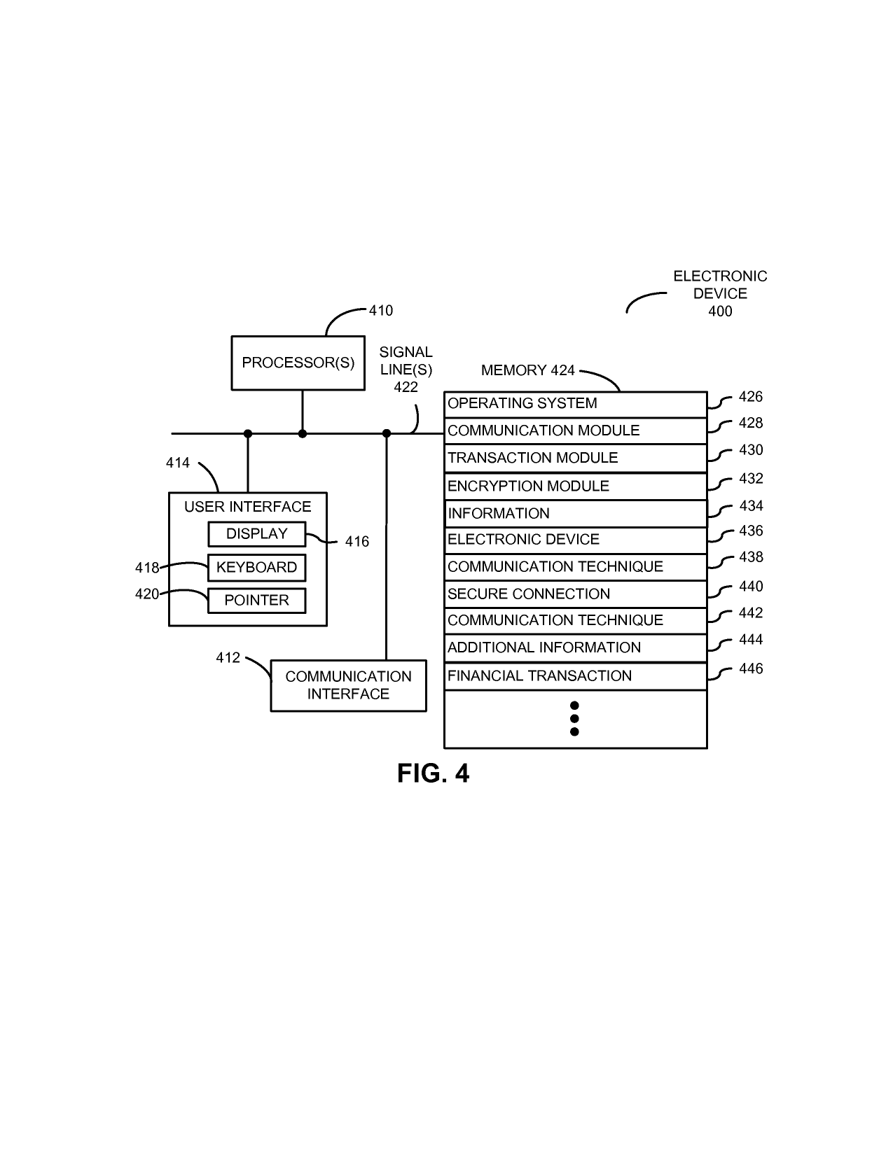

We now describe embodiments of the financial technique, which may be performed by a system (such as system 300 in FIG. 3) and/or an electronic device (such as electronic device 400 in FIG. 4) in this system. FIG. 1 presents a flow chart illustrating a method 100 for conducting a financial transaction. During operation, the electronic device exchanges, using a first communication technique (such as near-field communication), information with a second electronic device to establish a secure connection between the electronic device and the second electronic device when the electronic device and the second electronic device are proximate to each other (operation 110), such as physical contact between the electronic device and the second electronic device of a distance less than 3 cm. For example, the information may include a cryptographic key, such as a cryptographic key that is locally generated in at least one of the electronic device and the second electronic device. Alternatively or additionally, the information may include an identity attribute (such as identifiers of users of the electronic device and the second electronic device). Note that the secure connection may include a pairwise connection between the electronic device and the second electronic device.

Then, the secure connection is established (operation 112). In some embodiments, establishing the secure connection (operation 112) involves: providing the information to a service provider at a remote location from the electronic device and the second electronic device; and receiving connection information from the service provider which establishes the secure connection between the electronic device and the second electronic device. Alternatively or additionally, the electronic device and/or the second electronic device may establish the secure connection between the electronic device and the second electronic device based on the information. Thus, the information exchanged in operation 110 may be sufficient to establish the secure connection.

After the secure connection is established (operation 112), the electronic device hands off communication with the second electronic device from the first communication technique to a second communication technique (operation 114), where the second communication technique supports communication at a higher data rate and over longer distances (such as over several meters) than the first communication technique. For example, the second communication technique may include: Bluetooth™ (from the Bluetooth Special Interest Group of Kirkland, Wash.), wireless communication and/or the Internet. Therefore, after the secure connection is established (operation 112), the electronic device and the second electronic device may not need to remain in proximity to each other.

Moreover, the electronic device communicates, using the second communication technique and the secure connection, additional information associated with the financial transaction with the second electronic device (operation 116), where the additional information facilitates completion of the financial transaction. For example, the additional information may correspond to a multiple-stage financial transaction, where a given stage involves communication of at least some of the additional information between the electronic device and the second electronic device. In some embodiments, the additional information includes information associated with: an item to be purchased, a financial instrument used to pay for the item, a discount offer for the financial transaction, a discount offer for a second financial transaction after the financial transaction, a customer loyalty program, and/or a receipt for the financial transaction.

Note that the electronic device may perform the exchanging (operation 110) when a user of one of the electronic device and the second electronic device positions the electronic device and the second electronic device proximate to each other. Furthermore, after the electronic device and the second electronic device are positioned proximate to each other, the remaining operations in method 100 may be performed without further action by users of the electronic device and the second electronic device and/or, as noted previously, the electronic device and the second electronic device may not need to remain proximate to each other.

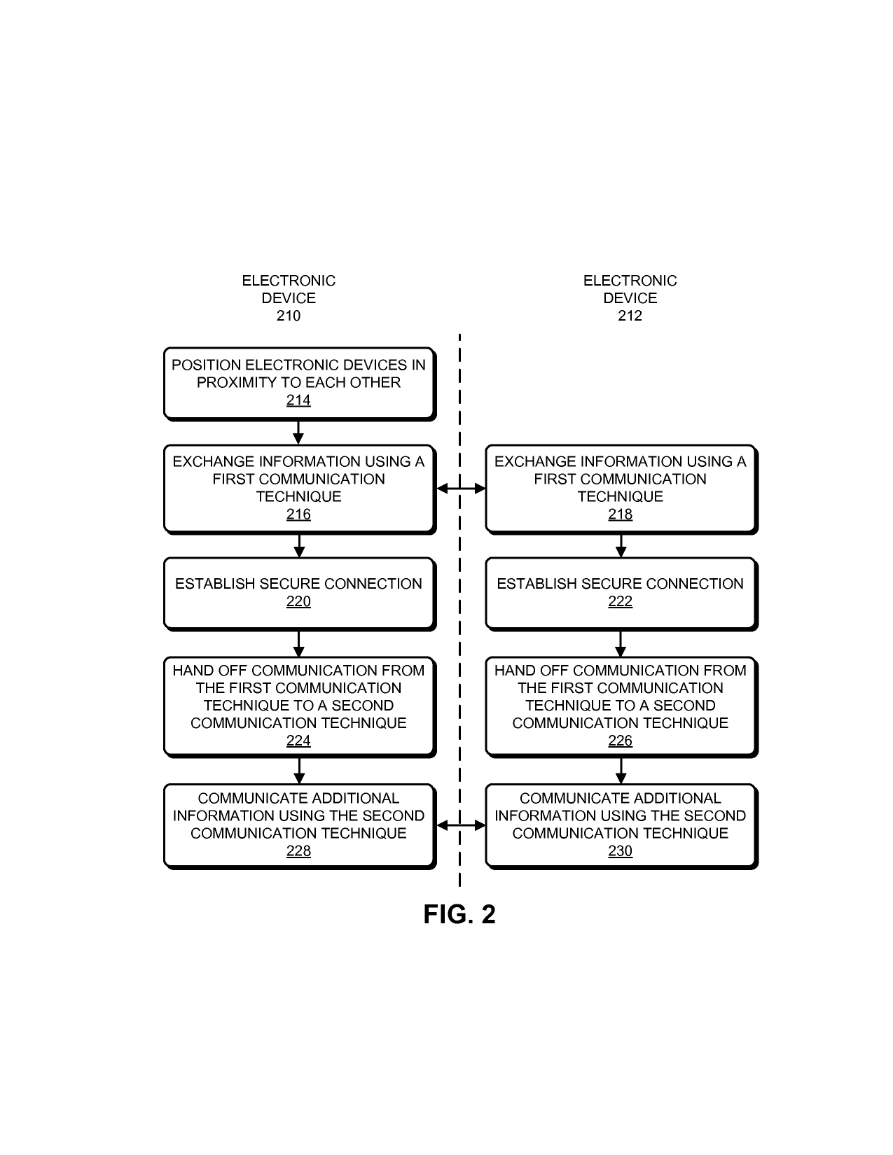

In an exemplary embodiment, the financial technique is implemented using two electronic devices, which communicate using different communication techniques, one of which may be mediated using near-field communication (NFC) and the other of which may be medicated using a network, such as a cellular-telephone network and/or the Internet. This is illustrated in FIG. 2, which presents a flow chart illustrating method 100 (FIG. 1). During this method, a user of electronic device 210 may position it in proximity (operation 214) to electronic device 212. When this occurs, electronic devices 210 and 212 may exchange information using a first communication technique (operations 216 and 218), which may be used by electronic devices 210 and 212 to establish a secure connection (operations 220 and 222) based on the information. For example, the secure connection may be established directly by electronic devices 210 and 212 and/or indirectly via communication with a (remotely located) service provider that provides connection information to electronic devices 210 and 212.

After the secure connection has been established, electronic devices 210 and 212 may hand off communication to a second communication technique (operations 224 and 226). Then, electronic devices 210 and 212 may communicate additional information (operations 228 and 230) with each other to complete the financial transaction.

In some embodiments of method 100 (FIGS. 1 and 2), there may be additional or fewer operations. Moreover, the order of the operations may be changed, and/or two or more operations may be combined into a single operation.

In an exemplary embodiment, the financial technique is used in conjunction with smartphones that are used as payment instruments, thereby allowing a wide variety of additional information (in addition to authorization) to be communicated between parties during a financial transaction, including: providing details of the payment instrument, providing details of the financial transaction, providing a receipt for the financial transaction, providing and/or redeeming loyalty offers, providing coupons, providing a receipt, etc. Moreover, these interactions during the financial transaction can be completed without requiring that a user's smartphone remain in contact (or close proximity) with a point-of-sale terminal (or an electronic device of the payee in the financial transaction) as would be the case if only the (short range) first communication technique (such as NFC) were used during the financial transaction.

For example, NFC may be used to establish the secure connection between the electronic devices. Note that, to initiate a mobile payment, a user (the payer in the financial transaction) may tap their cellular telephone on a payment terminal (and, more generally, on a point-of-sale terminal). For example, in response to the initial ‘tap’ or ‘touch’ between the electronic devices, a cryptographic key and connectivity parameters for a connection handoff may be exchanged, such as a media access control (MAC) address and/or a universally unique identifier (UUID) for Bluetooth™.

Once the secure connection has been established, the secure connection may be handed over to Bluetooth™, peer-to-peer WiFi™ (from the Wi-Fi Alliance of Austin, Tex.) or another type of communication technique that enables a rich user experience while continuously maintaining the secure connection between the electronic devices over an extended period of time. Using this other type of communication technique, the payer may accomplish subsequent interactions via their cellular telephone. For example, a screen or window with the financial transaction details may be displayed, along with an approve-or-cancel dialog box. Moreover, if a personal identification number (PIN) is requested, the PIN may be entered by the payer on their cellular telephone, and proof that the PIN was correctly entered may be provided to the payment terminal. Similarly, if a signature is requested, the payer may ‘sign’ on the cellular telephone and a digital image of their signature may be provided to the payment terminal. These additional interactions may occur without additional ‘touches’ or ‘taps’ between the electronic devices. Thus, the financial technique may involve a single ‘tap’ where the electronic devices are brought into close proximity or touch each other.

We now describe embodiments of the system and the electronic device, and their use. FIG. 3 presents a block diagram illustrating a system 300 that performs method 100 (FIGS. 1 and 2). In this system, a user of electronic device 210 may use a software product, such as a financial software application that is resident on and that executes on electronic device 210. (Alternatively, the user may interact with a web page that is provided by server 314 via network 312, and which is rendered by a web browser on electronic device 210. For example, at least a portion of the financial software application may be an application tool that is embedded in the web page, and which executes in a virtual environment of the web browser. Thus, the application tool may be provided to the user via a client-server architecture.) This financial software application may be a standalone application or a portion of another application that is resident on and which executes on electronic device 210 (such as a software application that is provided by server 314 or that is installed and which executes on electronic device 210).

As discussed previously, the user may use the financial software application to conduct the financial transaction. In particular, after bringing electronic 210 device into proximity with (or touching) electronic device 212, the financial software may exchange information with another instance of the financial software on electronic device 212 via the first communication technique (such as NFC).

This information may be used by electronic devices 210 and 212 to establish a secure connection (such as an encrypted connection) between electronic devices 210 and 212, which may be communicated between electronic devices 210 and 212 via the first communication technique. Alternatively, after exchanging the information, electronic devices 210 and 212 may communicate with server 314 via network 312 (i.e., via the second communication technique). In particular, electronic devices 210 and 212 may communicate, via network 312, the information to server 314 at a remote location (and which is associated with a service provider), which may, via network 312, provide connection information to electronic devices 210 and 212 that establishes the secure connection.

After the secure connection is established, the financial software on electronic devices 210 and 212 may hand off the communication to the second communication technique. Subsequently, the financial software on electronic devices 210 and 212 may communicate the additional information needed to complete the financial transaction between electronic devices 210 and 212 via network 312.

Note that information in system 300 may be stored at one or more locations in system 300 (i.e., locally or remotely). Moreover, because this data may be sensitive in nature, it may be encrypted. For example, stored data and/or data communicated via the first communication technique and/or network 312 may be encrypted.

FIG. 4 presents a block diagram illustrating an electronic device 400 that performs method 100 (FIGS. 1 and 2), such as electronic device 210 (FIGS. 2 and 3). Electronic device 400 includes one or more processing units or processors 410, a communication interface 412, a user interface 414, and one or more signal lines 422 coupling these components together. Note that the one or more processors 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in electronic device 400 may include volatile memory and/or non-volatile memory. More specifically, memory 424 may include: ROM, RAM, EPROM, EEPROM, flash memory, one or more smart cards, one or more magnetic disc storage devices, and/or one or more optical storage devices. Memory 424 may store an operating system 426 that includes procedures (or a set of instructions) for handling various basic system services for performing hardware-dependent tasks. Memory 424 may also store procedures (or a set of instructions) in a communication module 428. These communication procedures may be used for communicating with one or more computers and/or servers, including electronic devices, computers and/or servers that are remotely located with respect to electronic device 400.

Memory 424 may also include multiple program modules (or sets of instructions), including: transaction module 430 (or a set of instructions) and/or encryption module 432 (or a set of instructions). Note that one or more of these program modules (or sets of instructions) may constitute a computer-program mechanism.

During method 100 (FIGS. 1 and 2), transaction module 430 may exchange information 434 with electronic device 436 using communication technique 438. Using information 434, transaction module 430 may establish a secure connection 440 with electronic device 436.

After secure connection 440 is established, transaction module 430 may hand off communication with electronic device 436 to communication technique 442. Then, transaction module 430 may communicate additional information 444 with electronic device 436 using communication technique 442 to complete a financial transaction 446.

Because information in electronic device 400 may be sensitive in nature, in some embodiments at least some of the data stored in memory 424 and/or at least some of the data communicated using communication module 428 is encrypted using encryption module 432.

Instructions in the various modules in memory 424 may be implemented in: a high-level procedural language, an object-oriented programming language, and/or in an assembly or machine language. Note that the programming language may be compiled or interpreted, e.g., configurable or configured, to be executed by the one or more processors 410.

Although electronic device 400 is illustrated as having a number of discrete items, FIG. 4 is intended to be a functional description of the various features that may be present in electronic device 400 rather than a structural schematic of the embodiments described herein. In practice, and as recognized by those of ordinary skill in the art, the functions of electronic device 400 may be distributed over a large number of servers or computers, with various groups of the servers or computers performing particular subsets of the functions. In some embodiments, some or all of the functionality of electronic device 400 may be implemented in one or more application-specific integrated circuits (ASICs) and/or one or more digital signal processors (DSPs).

Electronic devices (such as electronic device 400), as well as computers and servers in system 300 (FIG. 3) may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 312 (FIG. 3) may include: the Internet, World Wide Web (WWW), an intranet, a cellular-telephone network, LAN, WAN, MAN, or a combination of networks, or other technology enabling communication between computing systems.

System 300 (FIG. 3) and/or electronic device 400 may include fewer components or additional components. Moreover, two or more components may be combined into a single component, and/or a position of one or more components may be changed. In some embodiments, the functionality of system 300 (FIG. 3) and/or electronic device 400 may be implemented more in hardware and less in software, or less in hardware and more in software, as is known in the art.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic-device-implemented method for completing a financial transaction, the method comprising:
exchanging, using a first communication technique, information between a first electronic device and a second electronic device to establish a secure connection between the first electronic device and the second electronic device when the first electronic device and the second electronic device are proximate to each other;
after the secure connection is established, handing off communication with the second electronic device from the first communication technique to a second communication technique, wherein the second communication technique supports communication at a higher data rate and over longer distances than the first communication technique; and
communicating, using the second communication technique and the secure connection, additional information associated with the financial transaction between the first electronic device and the second electronic device, wherein the additional information facilitates completion of the financial transaction.

2. The method of claim 1, wherein the secure connection is established when a user of one of the first electronic device and the second electronic device positions the first electronic device and the second electronic device proximate to each other.

3. The method of claim 2, wherein, after the first electronic device and the second electronic device are positioned proximate to each other, the remaining operations in the method are performed without further action by users of the first electronic device and the second electronic device.

4. The method of claim 1, wherein the first communication technique includes near-field communication.

5. The method of claim 1, wherein the second communication technique includes one of: Bluetooth™, wireless communication and the Internet.

6. The method of claim 1, wherein the information includes a cryptographic key.

7. The method of claim 6, wherein the cryptographic key is locally generated in one of the first electronic device and the second electronic device.

8. The method of claim 1, wherein the information includes an identity attribute.

9. The method of claim 1, wherein the secure connection includes a pairwise connection between the first electronic device and the second electronic device.

10. The method of claim 1, wherein proximate includes physical contact between the first electronic device and the second electronic device.

11. The method of claim 1, wherein, after the exchanging the information, the method further comprises:
providing the information to a service provider at a remote location from the first electronic device and the second electronic device; and
receiving connection information from the service provider which establishes the secure connection between the first electronic device and the second electronic device.

12. The method of claim 1, wherein, after exchanging the information, the method further comprises establishing the secure connection between the first electronic device and the second electronic device based on the information.

13. The method of claim 1, wherein the additional information corresponds to a multiple-stage financial transaction; and
wherein a given stage involves communication of at least some of the additional information between the first electronic device and the second electronic device.

14. The method of claim 1, wherein the additional information includes information associated with at least one of: an item to be purchased, a financial instrument used to pay for the item, a discount offer for the financial transaction, a discount offer for a second financial transaction after the financial transaction, a customer loyalty program, and a receipt for the financial transaction.

15. A computer-program product for use in conjunction with a computer system, the computer-program product comprising a non-transitory computer-readable storage medium and a computer-program mechanism embedded therein, to complete a financial transaction, the computer-program mechanism including:
instructions for exchanging, using a first communication technique, information between a first electronic device and a second electronic device to establish a secure connection between the first electronic device and the second electronic device when the first electronic device and the second electronic device are proximate to each other;
after the secure connection is established, instructions for handing off communication with the second electronic device from the first communication technique to a second communication technique, wherein the second communication technique supports communication at a higher data rate and over longer distances than the first communication technique; and
instructions for communicating, using the second communication technique and the secure connection, additional information associated with the financial transaction between the first electronic device and the second electronic device, wherein the additional information facilitates completion of the financial transaction.

16. The computer-program product of claim 15, wherein the computer-program mechanism includes instructions for performing the instructions for exchanging when a user of one of the first electronic device and the second electronic device positions the first electronic device and the second electronic device proximate to each other.

17. The computer-program product of claim 16, wherein, after the first electronic device and the second electronic device are positioned proximate to each other, the instructions for handing off and the instructions for communicating are performed without further action by users of the first electronic device and the second electronic device.

18. The computer-program product of claim 15, wherein the first communication technique includes near-field communication.

19. The computer-program product of claim 15, wherein the second communication technique includes one of: Bluetooth™, wireless communication and the Internet.

20. The computer-program product of claim 15, wherein, after the instructions for exchanging the information, the computer-program mechanism further includes:
instructions for providing the information to a service provider at a remote location from the first electronic device and the second electronic device; and
instructions for receiving connection information from the service provider which establishes the secure connection between the first electronic device and the second electronic device.

21. The computer-program product of claim 15, wherein, after the instructions for exchanging the information, the computer-program mechanism further includes instructions for establishing the secure connection between the first electronic device and the second electronic device based on the information.

22. A computer system, comprising:
a processor;
memory; and
a program module, wherein the program module is stored in the memory and configurable to be executed by the processor to complete a financial transaction, the program module including:
instructions for exchanging, using a first communication technique, information between a first electronic device and a second electronic device to establish a secure connection between the first electronic device and the second electronic device when the first electronic device and the second electronic device are proximate to each other;
after the secure connection is established, instructions for handing off communication with the second electronic device from the first communication technique to a second communication technique, wherein the second communication technique supports communication at a higher data rate and over longer distances than the first communication technique; and
instructions for communicating, using the second communication technique and the secure connection, additional information associated with the financial transaction between the first electronic device and the second electronic device, wherein the additional information facilitates completion of the financial transaction.
